(19) United States
(12) Patent Application Publication
(10) Pub. No.: US 2017/0241168 A1
(43) Pub. Date: Aug. 24, 2017

(54) MOTOR VEHICLE LOCK

(71) Applicant: Brose Schliesssysteme GmbH & Co. KG, Wuppertal (DE)

(72) Inventors: Joerg Reinert, Koenigsbrueck (DE); Peter Pszola, Bonn (DE); Markus Kothe, Velbert (DE); Axel Steinshorn, Wittighausen (DE)

(21) Appl. No.: 15/320,410

(22) PCT Filed: May 27, 2015
(86) PCT No.: PCT/EP2015/061620

§ 371 Date: Dec. 20, 2016

(30) Foreign Application Priority Data
Jun. 21, 2014 (DE) 10 2014 108 712.7

(51) Int. Cl. E05B 81/08; H02K 1/18; H02K 1/27; E05B 63/00; E05B 79/20

(52) U.S. Cl. CPC E05B 81/08; E05B 63/0065; E05B 79/20; H02K 1/2793; H02K 1/182; E05B 2063/0082

(57) ABSTRACT

A motor vehicle lock having a positioning element, especially a control shaft, and a drive unit for moving the positioning element, wherein the drive unit has a rotor and a stator, the stator having a coil arrangement and at least two magnetically conducting poles associated with the coil arrangement for conducting the magnetic field created by the coil arrangement. It is proposed that the poles each time form, with the rotor, an axial air gap relative to the geometrical rotor axis, possibly in dependence on the rotor position, and a first segment of the coil arrangement with at least two coils and a second segment of the coil arrangement with at least two coils are arranged along the geometrical rotor axis on opposite sides of the rotor.

### CROSS-REFERENCE TO RELATED APPLICATIONS

This application is a national stage application under 35 U.S.C. 371 of International Patent Application Serial No. PCT/EP2015/061620, entitled “Motor Vehicle Lock,” filed May 27, 2015, which claims priority from German Patent Application No. DE 10 2014 108 712.7, filed Jun. 21, 2014, the disclosure of which is incorporated herein by reference.

### FIELD OF THE TECHNOLOGY

The disclosure concerns a motor vehicle lock, a drive unit for moving a positioning element and a method for actuating a motor vehicle lock or a drive unit.

### BACKGROUND

The motor vehicle lock in question finds application in all kinds of lock elements of a motor vehicle. This includes in particular side doors, rear doors, tailgates, trunk lids, or engine hoods. These lock elements can also be designed basically in the manner of a sliding door.

Present-day motor vehicle locks are outfitted with a full array of functions, which can be initiated by means of electric drive units in a motorized manner. In the interest of a high operating reliability for all conceivable environmental conditions, especially in view of a possible icing of the motor vehicle lock, such drive units must produce relatively high driving forces or driving moments. At the same time, the structural space available for the drive units is extremely small. Moreover, the lowest possible costs play a most particular role in the area of motor vehicle locks.

The known motor vehicle lock (WO 2013/127531 A1), on which the disclosure is based, comprises a drive unit for moving a positioning element, having a rotor and a stator. The stator is outfitted with a coil arrangement with a total of four coils and accordingly four magnetically conducting poles associated with the coil arrangement for conducting the magnetic field created by the coil arrangement. Thanks to different stationary current flow through the coil arrangement, different magnetically stable driving positions can be established for the rotor, so that no end stops are needed when moving to the driving positions of the rotor.

A potential for optimization of the known motor vehicle lock is to boost the driving torques, which would be possible in theory by changing the design of the coils, although there are limits for this, dictated by structural space.

In another design for a drive unit of a motor vehicle lock (DE 10 2008 012 563 A1), the coil arrangement is outfitted with air coils, which interact with a permanent magnet arrangement at the rotor side. This leads to an especially economical arrangement. However, the drawback is the low efficiency and the less than optimal torque behavior of the drive unit.

### SUMMARY

One problem which the disclosure proposes to solve is to modify and configure the known motor vehicle lock so that the torque behavior is optimized in consideration of a small available structural space.

What is significant is the basic consideration that high driving moments can be realized with an axial flow machine in a compact design. Based on this, it has been recognized that the basic layout of an axial flow machine enables a partitioning of the coil arrangement into two segments, which are axially offset relative to each other in relation to the geometrical rotor axis and which are situated on opposite sides of the rotor along the geometrical rotor axis. This means that the first segment of the coil arrangement is situated, especially in its entirety, on one side of the rotor and the second segment of the coil arrangement, especially in its entirety, is situated on an opposite side of the rotor along the geometrical rotor axis.

This means that the coil arrangement is divided axially into the above two segments in relation to the geometrical rotor axis. In this way, additional structural space is created for the coils of the coil arrangement, without the outer dimensions of the drive unit becoming overly large on the whole.

Specifically, it is proposed that the magnetically conducting poles each time form, with the rotor, an axial air gap relative to the geometrical rotor axis, possibly in dependence on the rotor position, so that an axial working field which is essential to axial flow machines can be formed. By the term “axial gap” is meant here that the gap spans a distance in relation to the axial direction of the rotor axis.

According to the proposal, it is additionally provided, as indicated above, that a first segment of the coil arrangement with at least one coil and a second segment of the coil arrangement with at least one coil are offset axially relative to each other in regard to the geometrical rotor axis and arranged along the geometrical rotor axis on opposite sides of the rotor. This already produces twice the structural space for the coil arrangement on the opposite sides of the rotor, disregarding a certain lengthening of the drive unit. But such a lengthening is usually acceptable.

Basically the coils of the two segments of the coil arrangement can be oriented to each other in regard to the geometrical rotor axis. In an embodiment, however, at least one coil of the first segment of the coil arrangement is arranged with an angular offset in regard to the geometrical rotor axis with respect to the at least one coil of the second segment of the coil arrangement. This enables a greater variability in the generating of the magnetic working field.

In an embodiment, the rotor comprises a disk-shaped permanent magnet arrangement, whose end faces running transversely to the geometrical rotor axis are turned toward the magnetically conducting poles to form the axial air gaps. The magnetic field generated by the coil arrangement interacts with the magnetic field of the permanent magnet arrangement so that a driving moment is produced on the rotor. This corresponds to the familiar mode of functioning of an axial flow machine.

In an embodiment it becomes clear that the proposed solution allows greater flexibility in the design of the coil arrangement, since the coils of the two opposite segments of the coil arrangement can overlap with each other. In this way, the inductances of the coils can be boosted in particular by larger coil diameter and larger numbers of winding turns.

An embodiment shows an especially advantageous possibility of closing the magnetic circuit for the magnetic field generated by a segment of the coil arrangement. The overlapping of the pole shoes proposed here affords the possibility, in an embodiment, that the pole shoes themselves provide a closing of the magnetic circuit for two pole shoes arranged on the other side of the rotor.

A further utilization of the structural space is disclosed, whereby the coils and/or the poles deviate from a circular configuration in the cross section perpendicular to the geometrical rotor axis. In this way, the inductances of the coils of the coil arrangement can be boosted accordingly and in particular adapted to the particular structural space requirements.

In an embodiment, the motor vehicle lock is outfitted with a lock mechanism which can be placed in different functional states. Examples of this are the functional states “locked”, “unlocked”, “theft-proof”, “child-resistant locked” and “child-resistant unlocked”.

The aforementioned functional states pertain to the possibility of the opening of a motor vehicle door or the like by means of an inner door handle and by means of an outer door handle. In the functional state “locked”, it can be opened from the inside, but not from the outside. In the functional state “unlocked”, it can be opened from both the inside and the outside. In the functional state “theft-proof”, it cannot be opened either from the inside or the outside. In the functional state “child-resistant locked” it can be unlocked from the inside, but not opened either from the inside or the outside. In the functional state “child-resistant unlocked” it can be opened from the outside, but not from the inside.

In an embodiment, the positioning element can be brought by means of the drive unit into at least two control positions in order to establish corresponding functional states of the lock mechanism. Further, the control positions correspond each time to precisely one functional state, so that the particular functional states can be established accordingly by means of the drive unit.

According to an embodiment, it is proposed that at least two magnetically stable driving positions of the rotor can be generated by different stationary current flow through the coil arrangement and the concomitant magnetic interaction between rotor and stator. The phrase “magnetically stable” means here that the current flow through the coil arrangement with the resulting magnetic field ensures that the rotor upon deflection out from the respective driving position is constantly driven back into this driving position. Of course, this pertains to a deflection of the positioning element in both directions of movement. The term “stationary current flow” means here that the established current flow does not change in the time interval. The term “current flow” should be taken generally to encompass both the applying of an electrical voltage and the imposing of an electrical current in the coil arrangement. The voltage or the current here can also be pulsed etc. In the most simple case, for a stationary current flow in the above meaning a constant voltage is switched onto the corresponding part of the coil arrangement.

As a result, the different functional states mentioned above as examples of the lock mechanism can here be reached through the generating of magnetically stable driving positions. Thus, no end stop is needed for moving into the driving positions.

It should be pointed out for clarity that the current flow is the cause of the magnetic stability and that the magnetic stability may go away when the current flow disappears, depending on the design of the drive unit.

According to a further teaching, a drive unit is disclosed as such for the movement of a positioning element, especially a control shaft of a proposed motor vehicle lock. One may refer to all of the remarks for the proposed motor vehicle lock.

According to a further teaching, a method is disclosed for the actuating of a proposed motor vehicle lock or a proposed drive unit.

According to the further teaching, what is important is the consideration that the coil arrangement undergoes different stationary current flow for the moving to at least two magnetically stable driving positions of the positioning element. The benefits associated with this have already been explained above.

An embodiment provides a motor vehicle lock having a positioning element, especially a control shaft, and a drive unit for moving the positioning element, wherein the drive unit has a rotor and a stator, the stator having a coil arrangement and at least two magnetically conducting poles associated with the coil arrangement for conducting the magnetic field created by the coil arrangement, wherein the poles each time form, with the rotor, an axial air gap relative to the geometrical rotor axis, possibly in dependence on the rotor position, and a first segment of the coil arrangement with at least one coil and a second segment of the coil arrangement with at least one coil are offset axially relative to each other in regard to the geometrical rotor axis and arranged along the geometrical rotor axis on opposite sides of the rotor.

In an embodiment, at least one coil of the first segment of the coil arrangement is arranged with an angular offset in regard to the geometrical rotor axis with respect to the at least one coil of the second segment of the coil arrangement.

In an embodiment, the magnetically conducting poles associated with the coil arrangement are arranged on opposite sides of the rotor along the geometrical rotor axis, and thus, possibly depending on the rotor position, form with the rotor axial air gaps in regard to the geometrical rotor axis on both sides of the rotor.

In an embodiment, the rotor comprises a permanent magnet arrangement, the permanent magnet arrangement is axially magnetized in relation to the geometrical rotor axis, the rotor can be substantially disk-shaped and has at least two disk segments that are alternatingly magnetized opposite to each other, and furthermore the disk segments each extend over the same angular dimension in regard to the geometrical rotor axis.

In an embodiment, at least a portion of the coils of the two segments of the coil arrangement overlap with each other when viewed in the direction of the geometrical rotor axis.

In an embodiment, the first segment of the coil arrangement has at least two coils, such as precisely two coils, and the second segment of the coil arrangement has at least two coils, such as precisely two coils.

In an embodiment, at least one portion of the coils of the coil arrangement are oriented by their respective coil axes parallel to the geometrical rotor axis, and/or at least one of the two segments of the coil arrangement comprises at least one coil pair of two coils, whose coil axes lie on a connection line running through the geometrical rotor axis, the two segments of the coil arrangement each comprise one coil pair of two coils, whose coil axes each lie on a connection line running through the geometrical rotor axis, and the connection lines of the two oppositely situated coil pairs stand at an angle of around 45° to each other in regard to the geometrical rotor axis, or at an angle of around 90°.

In an embodiment, the coils of the first segment of the coil arrangement have the same angle position relative to each other with regard to the geometrical rotor axis as do the coils of the second segment of the coil arrangement.

In an embodiment, the first segment of the coil arrangement is arranged with an angular offset in regard to the geometrical rotor axis from the second segment of the coil arrangement, the first segment of the coil arrangement is arranged with an angular offset of around 45° or around 90° in regard to the geometrical rotor axis from the second segment of the coil arrangement.

In an embodiment, each pole is associated with at least one coil, each pole can be associated with precisely one coil.

In an embodiment, each pole is oriented to the coil axis of a coil associated with the respective pole, such as each pole runs through an associated coil.

In an embodiment, each pole has a pole shoe, which faces toward the rotor in order to form the respective air gap.

In an embodiment, at least a portion of the pole shoes associated with the two segments of the coil arrangement overlap each other when viewed in the direction of the geometrical rotor axis, such as the pole shoes run around the geometrical rotor axis at least for an angle region.

In an embodiment, a pole shoe of a pole of a segment of the coil arrangement serves as a circuit closing element for two pole shoes of the respective other segment of the coil arrangement.

In an embodiment, the poles are magnetically coupled in pairs via circuit closing plates.

In an embodiment, the coils of the two segments of the coil arrangement are configured as identical parts and/or the poles of the two segments of the coil arrangement are configured as identical parts and/or the circuit closing plates of the two segments of the coil arrangement are configured as identical parts.

In an embodiment, the coils and/or the poles have an elongated, especially a substantially elliptical or substantially triangular configuration, at least for a portion, in the cross section perpendicular to the geometrical rotor axis, and they can be arranged with their elongated dimension substantially tangentially in relation to the geometrical rotor axis.

In an embodiment, the motor vehicle lock comprises a lock mechanism which can be placed in different functional states such as “locked”, “unlocked”, “theft-proof”, “child-resistant locked” and “child-resistant unlocked”.

In an embodiment, the positioning element can be placed by means of the drive unit in at least two control positions, in order to establish functional states of the lock mechanism such as “locked”, “unlocked”, “theft-proof”, “child-resistant locked” and “child-resistant unlocked”.

In an embodiment, for the establishing of the different functional states at least one movable functional element is provided, the positioning element standing or being able to be brought into driving engagement with the functional element or being part of the functional element, and the functional element can be braced against a control segment of the control shaft.

In an embodiment, the functional element is designed as a wire or strip and it can be deflected into different functional positions, the functional element can be designed as a resilient wire or strip, and thus as a bending functional element it can be brought into different functional positions.

In an embodiment, the first segment of the coil arrangement comprises at least one coil pair, such as precisely one coil pair, and the second segment of the coil arrangement comprises at least one coil pair, such as precisely one coil pair, which are each actuated in pairs, such as the two coils of a coil pair are electrically coupled, such as switched in series or in parallel.

In an embodiment, at least two magnetically stable driving positions of the rotor, such as at least three magnetically stable driving positions of the rotor, further more than three magnetically stable driving positions of the rotor can be generated by different stationary current flow through the coil arrangement and the concomitant magnetic interaction between rotor and stator.

In an embodiment, at least two magnetically stable driving positions of the rotor, such as at least three magnetically stable driving positions of the rotor, further more than three magnetically stable driving positions of the rotor can be generated by current flow through the coils of the coil arrangement in a coil combination associated with the respective driving position in a direction of current flow associated with the respective driving position.

In an embodiment, at least one magnetically stable driving position is a control position of the positioning element to establish a functional state of the lock mechanism such as “locked”, “unlocked”, “theft-proof”, “child-resistant locked” and “child-resistant unlocked”.

An embodiment provides a drive unit for moving a positioning element, especially a control shaft, of a motor vehicle lock, wherein the drive unit has a rotor and a stator, the stator having a coil arrangement and at least two magnetically conducting poles associated with the coil arrangement for conducting the magnetic field created by the coil arrangement, wherein the poles each time form, with the rotor, an axial air gap relative to the geometrical rotor axis, possibly in dependence on the rotor position, a first segment of the coil arrangement with at least one coil and a second segment of the coil arrangement with at least one coil are arranged on opposite sides of the rotor along the geometrical rotor axis, at least one coil of the first segment of the coil arrangement is arranged with an angular offset in relation to the geometrical rotor axis with respect to the at least one coil of the second segment of the coil arrangement.

In an embodiment, the coil arrangement experiences different stationary current flow for the occupying of at least two magnetically stable driving positions of the rotor, such as at least three magnetically stable driving positions of the rotor, and further more than three magnetically stable driving positions of the rotor.

In an embodiment, in order to occupy at least two magnetically stable driving positions, the coils of the coil arrangement experience a stationary current flow in a coil combination associated with the respective driving position in a flow direction associated with the respective driving position.

### BRIEF DESCRIPTION OF THE DRAWINGS

In the following, various embodiments shall be explained more closely with the aid of drawings representing only one sample embodiment. In the drawings

FIG. 1 depicts various components of a proposed motor vehicle lock for an embodiment,

FIG. 2 depicts the drive unit of the motor vehicle lock per FIG. 1 in a schematic, perspective representation without outer housing,

FIG. 3 depicts the drive unit per FIG. 2 without rotor housing,

FIG. 4 depicts the drive unit per FIG. 3 in a sectional view along the sectioning line V-V,

FIG. 5 depicts the poles of the drive unit per FIG. 3 in a view otherwise isolated from the drive unit, and

FIG. 6 depicts the permanent magnet arrangement of the drive unit per FIG. 3 in a view otherwise isolated from the drive unit.

### DETAILED DESCRIPTION

It should be pointed out in advance that only the components of the proposed motor vehicle lock that are necessary for the explanation of the teaching have been represented in the drawings. Accordingly, a lock latch interacting in typical manner with a lock bolt or the like and held by means of a retaining pawl in a main locking position and in an optionally present prelocking position is not represented in the drawings.

The motor vehicle lock here comprises a positioning element 2 which can be moved about a positioning element axis 1, being here a control shaft. All embodiments regarding the control shaft 2 apply accordingly to all other kinds of positioning elements.

The positioning element 2 can basically be configured in multiple pieces, for example, it can have at least two shaft segments coupled together, especially connected together, and oriented to the positioning element axis 1. But it is also conceivable for the positioning element 2 to be a single piece.

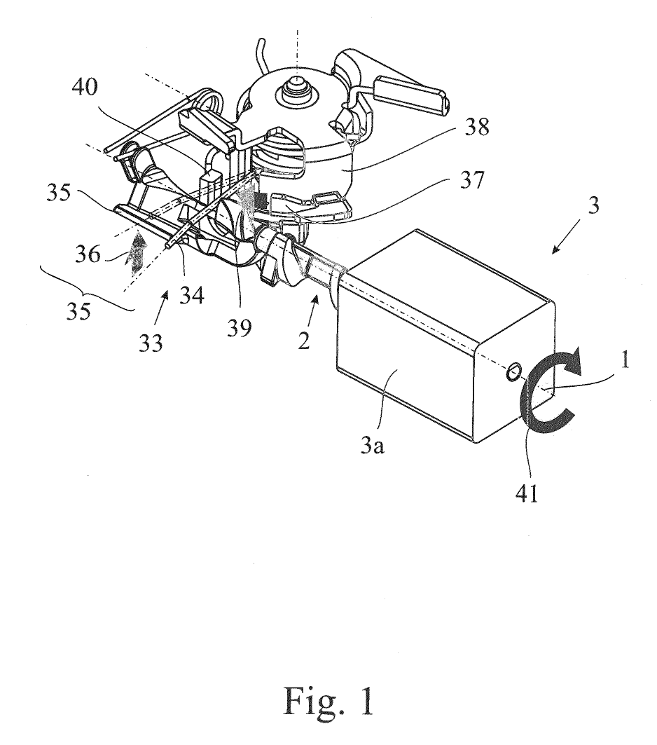

Moreover, the motor vehicle lock is outfitted with a drive unit 3 for moving the positioning element 2. The drive unit 3 here serves for establishing different functional states of the motor vehicle lock, as is explained in detail further below. In FIG. 1 the drive unit 3 is shown with a drive unit housing 3a, although this need not necessarily be provided for the proposed solution.

The drive unit 3 comprises a rotor 4 and a stator 5 associated with the positioning element 2, wherein the stator 5 comprises a coil arrangement 6 and at least two magnetically conducting poles 7-10 associated with the coil arrangement 6 for conducting the magnetic field created by the coil arrangement 6. The poles 7-10 each time form, with the rotor 4, an axial air gap 11a, 11b relative to the geometrical rotor axis 4a, possibly in dependence on the rotor position. The term “axial air gap” was explained further above.

Thus, according to the proposal, the drive unit 3 of the motor vehicle lock has the fundamental structure of an axial flow motor. With the magnetic working field critical to the generating of driving moments, being axial in relation to the geometrical rotor axis 4a, relatively large torques can be generated with a compact design.

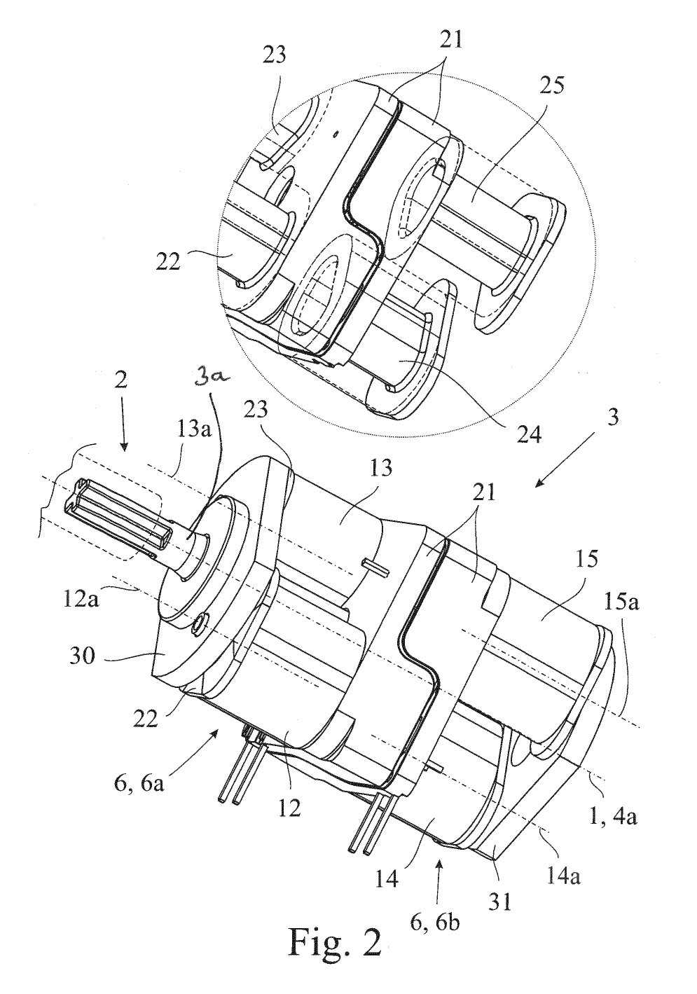

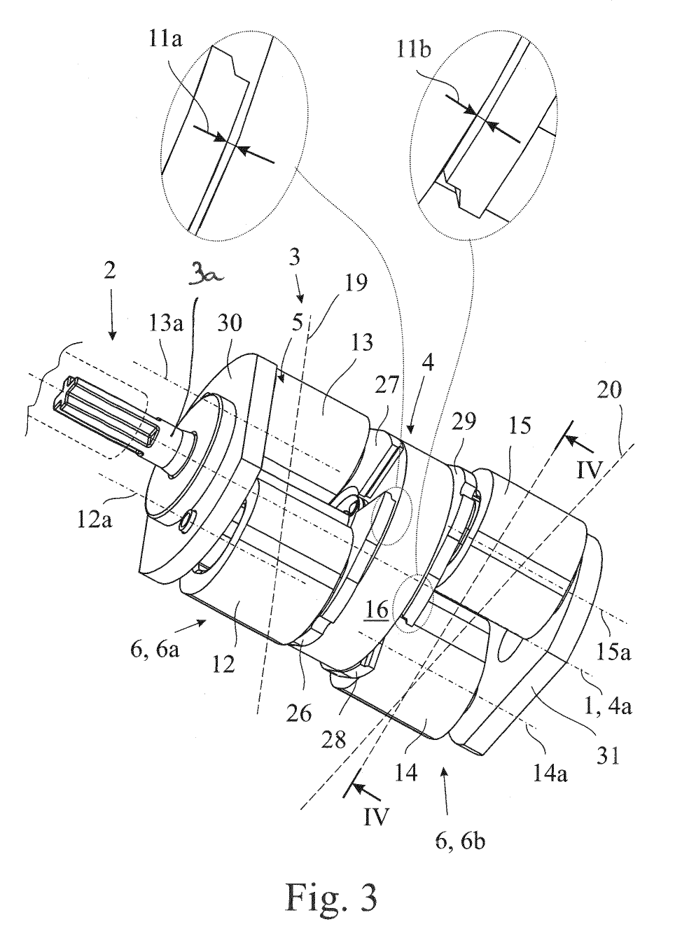

A joint consideration of FIGS. 2 and 3 shows that the coil arrangement 6 is divided into two parts by means of the rotor 4. A first segment 6a of the coil arrangement 6 with at least one coil 12,13, such as at least two coils 12,13, and a second segment 6b of the coil arrangement 6 with at least one coil 14, 15, such as with at least two coils 14,15, are arranged offset axially from each other in regard to the geometrical rotor axis 4a and on opposite sides of the rotor 4 along the geometrical rotor axis 4a. Here the first segment 6a of the coil arrangement 6 and the second segment 6b of the coil arrangement 6 are each arranged entirely on opposite sides of the rotor 4 along the geometrical rotor axis 4a.

It emerges directly from the representation of FIG. 2 that, as compared to an arrangement in which all the coils 12-15 of the coil arrangement 6 are arranged on one side of the rotor 4, much more structural space is available for the realization of the coils 12-15.

The extension of the drive unit 3 in the radial direction relative to the geometrical rotor axis 4a is advantageously slight. In the sample embodiment shown, this is due to the fact that the coil arrangement 6 is arranged solely on the two opposite sides of the rotor 4 along the geometrical rotor axis 4a, and not sideways to the rotor 4, for example. The term “sideways” here corresponds to a radial offset in relation to the geometrical rotor axis 4a.

The two segments 6a, 6b of the coil arrangement 6 are each spaced apart slightly from the rotor 4 in the direction of the geometrical rotor axis 4a. The two segments 6a, 6b of the coil arrangement 6 extend here in opposite axial directions in relation to the geometrical rotor axis 4a.

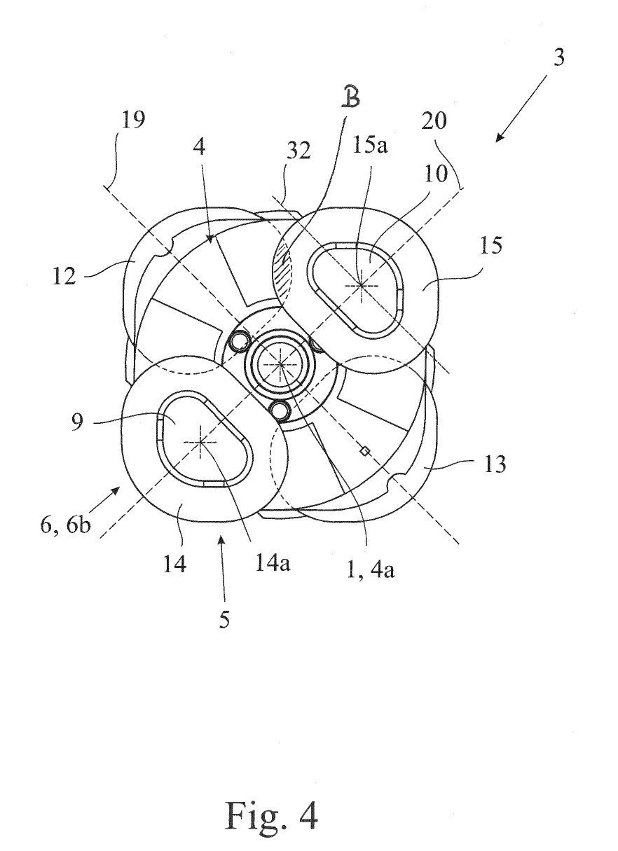

FIG. 4 shows best that, in the sample embodiment depicted, at least one coil 12, 13 of the first segment 6a of the coil arrangement 6 is arranged with an angular offset in relation to the geometrical rotor axis 4a from the coils 14,15 of the second segment 6b of the coil arrangement 6. Hence, at least one coil 12,13 of the first segment 6a of the coil arrangement 6 is provided that is arranged accordingly offset in angle relative to all coils 14, 15 of the second segment 6b of the coil arrangement 6 arranged on the opposite side of the rotor 4. Here, all coils 12,13 of the first segment 6a of the coil arrangement 6 are arranged accordingly with an angular offset from each other.

In accordance with the two-part division of the coil arrangement 6, the poles 7-10 associated with the coil arrangement 6 are also arranged on opposite sides of the rotor 4. Accordingly, the magnetically conducting poles 7, 8; 9, 10 associated with the coil arrangement 6 are arranged on opposite sides of the rotor 4 along the geometrical rotor axis 4a. In this way, the poles 7-10, possibly depending on the rotor position, form with the rotor 4 axial air gaps 11a, 11b on both sides of the rotor 4 in relation to the geometrical rotor axis 4a.

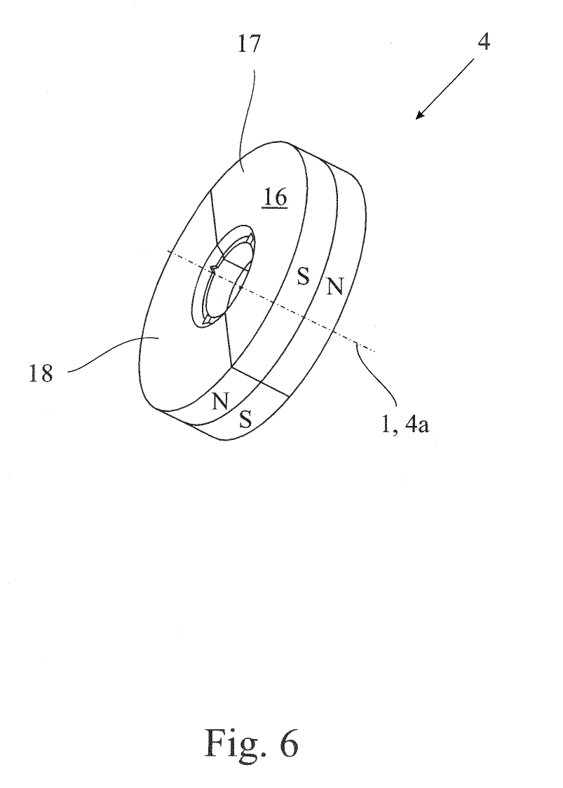

FIG. 3 shows moreover that the rotor 4 comprises a permanent magnet arrangement 16, which here is axially magnetized in relation to the geometrical rotor axis 4a. The axial magnetization is indicated in FIG. 6.

The rotor 4, as can likewise be seen in the representation of FIG. 6, is substantially disk-shaped. Here it comprises precisely two disk segments 17,18, which are alternatingly magnetized opposite to each other. Basically, more than two disk segments 17,18, and in some embodiments more than three disk segments 17,18 can be provided. The disk segments 17,18 can have any given shape and in particular can be formed as ring segments.

Basically it can be provided that the disk segments 17,18 each extend over different angular dimensions in relation to the geometrical rotor axis 4a. Here, however, the disk segments 17,18 each extend over the same angular dimension in regard to the geometrical rotor axis 4a.

Thanks to the proposed arrangement of the coils 12-15 on both sides, the possibility is afforded of having at least a portion of the coils 12-15 of the two segments 6a of the coil arrangement 6 overlapping with each other when viewed in the direction of the geometrical rotor axis 4a. This can be seen from the representation of FIG. 4. This affords the above mentioned flexibility in the design of the coils 12-15 in terms of shape and size. For example, an overlap region is shown hatched and indicated by reference sign B in FIG. 4.

Because the coils 12-15 are arranged with an axial offset in relation to the geometrical rotor axis 4a, there is no collision between the coils 12-15 here, despite the aforesaid overlap.

The coil arrangement 6 can basically have a different number of coils 12-15. Given the fact that not more than eight driving positions need to be occupied for the proposed motor vehicle lock, the outfitting of the coil arrangement 6 with a total of four coils for the actuation system yet to be described has proven to be advantageous. The first segment 6a of the coil arrangement 6 here has precisely two coils 12,13, while the second segment 6b of the coil arrangement 6 likewise has precisely two coils 14,15. As can be seen in the drawings, the coil arrangement 6 can accommodate additional coils. For example, it can be provided that the two segments 6a, 6b of the coil arrangement 6 each comprise precisely three coils.

Because the magnetic field generated by the coil arrangement 6 is conducted across the poles 7-10, the coils 12-15 can basically have different orientations. Here, however, the coils 12-15 of the coil arrangement 6 are oriented by their respective coil axes 12a-15a parallel to the geometrical rotor axis 4a. This can basically also be done for only a portion of the coils 12-15.

Alternatively or additionally, at least one of the two segments 6a, 6b of the coil arrangement 6 comprises at least one coil pair of two coils 12,13; 14,15, whose coil axes 12a, 13a; 14a, 15a lie on a connection line 19, 20 running through the geometrical rotor axis 4a. Here, it is provided that the two segments 6a, 6b of the coil arrangement 6 each comprise one coil pair of two coils 12, 13; 14, 15, whose coil axes 12a, 13a; 14a, 15a lie on a connection line 19, 20 running through the geometrical rotor axis, wherein the resulting connection lines 19, 20 of the two oppositely situated coil pairs stand at an angle of around 90° to each other in regard to the geometrical rotor axis 4a. This can be seen from the representation of FIG. 4. Depending on the application, it can also be advantageous for the resulting connection lines 19, 20 to stand at a different angle, especially an angle of around 45° to each other in regard to the geometrical rotor axis 4a.

It is seen from a joint consideration of FIGS. 3 and 4 that the coils 12,13 of the first segment 6a of the coil arrangement 6 have the same angle position relative to each other with regard to the geometrical rotor axis 4a as do the coils 14, 15 of the second segment 6b of the coil arrangement 6. Here, the two segments 6a, 6b of the coil arrangement 6 are even configured identical to each other.

In the sample embodiment represented, the first segment 6a of the coil arrangement 6 is therefore arranged with an angular offset in regard to the geometrical rotor axis 4a from the second segment 6b of the coil arrangement 6. In some embodiments, as indicated above in the context of the coil pairs, this is an angular offset of around 90°, especially an angular offset of around 45°.

Each pole 7-10 is associated with at least one coil 12-15, here precisely one coil 12-15. Further, each pole 8-10 is oriented to the coil axis 12a-15a of a coil 12-15 associated with the respective pole 7-10. One can see from a joint consideration of FIG. 3-5 that each pole 7-10 here runs through an associated coil 12-15.

Basically it can also be advantageous for several coils 12-15 to be associated with each pole 8-10 or for the one coil 12-15 to be associated with several poles 8-10.

FIG. 2 shows that the drive unit 3 comprises a rotor housing 21, which substantially accommodates the rotor 4. It is of interest here that the rotor housing 21 also provides a pole housing 22-25 for each pole 7-10. The pole housing 22-25 provides an electrical insulation between the coils 12-15 and the poles 7-10.

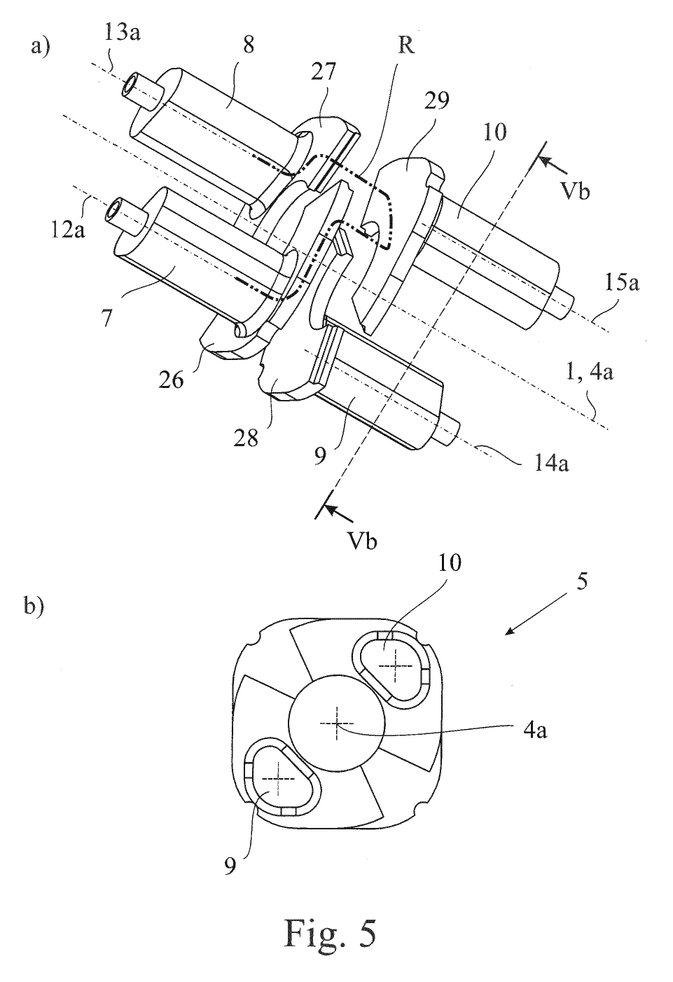

The depicted configuration of the poles 7-10 is of special interest. Each pole 7-10 has a pole shoe 26-29, which is turned toward the rotor 4 in order to form the respective air gap 11a, 11b. The form of the pole shoes 26-29 is best seen from a joint consideration of FIGS. 4 and 5. FIGS. 5a and 5b show that at least a portion of the pole shoes 26-29 associated with the two segments 6a, 6b of the coil arrangement 6 overlap each other when viewed in the direction of the geometrical rotor axis 4a. Here, this is realized in that the pole shoes 26-29 run around the geometrical rotor axis 4a for at least one angular region.

Because the pole shoes 26-29 are arranged with an angular offset in regard to the geometrical rotor axis 4a, there is no collision here between the pole shoes 26-29, despite the above overlapping.

The arrangement and configuration of the pole shoes 26-29 is such that a pole shoe 26-29 of a pole 7-10 of a segment 6a of the coil arrangement 6 serves as a circuit closing element for two pole shoes 26-29 of the respective other segment 6b of the coil arrangement 6. FIG. 5a shows as an example the field variation R, in which the magnetic field lines run through the pole 7, the pole shoe 26, the pole shoe 29, the pole shoe 27 and the pole 8. Hence, each pole shoe 26-29 can serve as a circuit closing element for the magnetic field of the respective oppositely situated segment 6a, 6b of the coil arrangement 6. The poles 7-10 are magnetically coupled to each other at least in pairs by a magnetic conducting arrangement. Here, the poles 7,8; 9,10 are magnetically coupled to each other in pairs by circuit closing plates 30,31.

The drive unit comprises a drive shaft 3a, which is coupled in a driving manner with the positioning element 2. The drive shaft 3a in turn is coupled in a driving manner with the rotor 4 and in this case extends at least through the first segment 6a of the coil arrangement 6.

In the sample embodiment represented, the coils 12-15 of the two segments 6a, 6b of the coil arrangement 6 are configured as identical parts. Moreover, here the poles 7-10 of the two segments 6a, 6b of the coil arrangement 6 are configured as identical parts. Finally, here the circuit closing plates 30, 31 of the two segments 6a, 6b of the coil arrangement 6 are configured as identical parts. The configuration of the respective components as identical parts has manufacturing advantages in particular.

An especially good utilization of the available structural space results in that the coils 12-15 and/or poles 7-10 deviate from a circular configuration in the cross section perpendicularly to the geometrical rotor axis 4a. In some embodiments, the coils 12-15 and/or the poles 7-10 have an elongated, especially substantially elliptical or, as represented in FIG. 4, substantially triangular configuration, at least for a portion, in the cross section to the geometrical rotor axis 4a. The coils 12-15 and poles 7-10 are arranged here with their elongated dimension substantially tangentially in relation to the geometrical rotor axis 4a. This can be seen from the representation of FIG. 4, in which the elongated dimension of the coil 13 and the pole 8 in the cross section is designated by the reference sign 32.

As already pointed out, the drive unit 3 serves to adjust various functional states of the motor vehicle lock. For this, the motor vehicle lock comprises first of all a lock mechanism 33, which can be placed in various functional states such as “locked”, “unlocked”, “theft-proof”, “child-resistant locked” and “child-resistant unlocked”. The meaning of these functional states for the possibility of opening the motor vehicle door etc. from the inside and from the outside has already been explained in the general portion of the specification. In this context, it should be pointed out that the lock mechanism 33 can be brought by means of the drive unit 3 in any given selection of the above functional states. In particular, it can be provided that the lock mechanism 33 by means of the drive unit 3 can only be brought into the functional states “locked” and “unlocked”. Moreover, it is conceivable that the functional state “theft-proof” can also be established by means of the drive unit 3 in addition to the latter two mentioned functional states.

Here, the positioning element 2, especially the control shaft 2, can be brought by means of the drive unit 3 into at least two control positions, in order to establish functional states such as “locked”, “unlocked”, “theft-proof”, “child-resistant locked” and “child-resistant unlocked”. In some embodiments, each control position of the positioning element 2 corresponds to a functional state of the lock mechanism 33, so that the positioning element 2 is to be brought into the corresponding control position for the establishing of the particular functional state.

For the establishing of the different functional states, the lock mechanism 33 is outfitted with a movable functional element 34, the positioning element 2 standing or being able to be brought directly or indirectly into driving engagement with the functional element 34. For clarification, it should be pointed out that the driving engagement can also be realized through any given number of gear elements. Basically, however, it can also be provided that the positioning element 2 is part of the functional element 34.

In some embodiments, the functional element 34 is braced on a control segment 35 of the control shaft 2. Depending on the position of the control shaft 2, the functional element 34 will be moved substantially perpendicular to the positioning element axis 1, as represented in FIG. 1 by the motion arrow 36 and by the broken-line representation of the functional element 34. The control segment 35 can be outfitted with a cam 35a, as represented in FIG. 1, against which the functional element 34 is braced accordingly. Depending on the position of the control shaft 2, the bracing of the functional element 34 against the cam 35a results in a deflection of the functional element 34 in the direction of the motion arrow 36.

The control shaft 2 can be brought by means of the drive unit 3 into at least two control positions, here into a total of five control positions, in order to establish the functional states of the motor vehicle lock, here the functional states “locked”, “unlocked”, “theft-proof”, “child-resistant locked” and “child-resistant unlocked”.

The design of the proposed motor vehicle lock is especially simple on account of the fact that the functional element 34 is configured as a wire and can be deflected into various functional positions along the motion arrow 36. Basically it is also conceivable for the functional element 34 to be designed as strips. Here, the functional element 34 is designed as a resilient wire or strip, and thus as a bending functional element it can be brought into the different functional positions.

In the following, the mode of functioning of the motor vehicle lock shall be explained in the functional states “unlocked” and “child-resistant unlocked”. Moreover, for an explanation of the fundamental mode of functioning of the motor vehicle lock with resilient functional element 34 one should refer to the international patent application WO 2009/040074 A1, which belongs to the applicant and whose contents are thus made subject matter of the present application.

In the functional state “unlocked”, the functional element 34 is in its lower position designated by the solid line in FIG. 1. The functional element 34 is situated in the movement range of an inside activation lever 37, which in the installed state is coupled to an inner door handle, and also in the movement range of an outside activation lever 38, which in the installed state is coupled to an outside door handle. A movement of the inside activation lever 37 or the outside activation lever 38 in the direction of the motion arrow 39 results in the functional element 34 following the movement of the respective lever 37, 38, perpendicular to its extension, striking the retaining pawl 40 only suggested in FIG. 1 and lifting and carrying this along, again in the direction of the motion arrow 39.

A movement of the control shaft 2 in the direction of the motion arrow 41 by 90° from the position represented in FIG. 1 results in an establishing of the functional state “child-resistant unlocked”. In this state, the functional element 34 is in the position shown by broken line in FIG. 1. A movement of the inside activation lever 37 in the direction of the motion arrow 39 thus has no effect on the functional element 34 and the retaining pawl 40. However, the functional element 34 is still in the movement range of the outside activation lever 38, so that a lifting of the retaining pawl 40 and thus an opening of the motor vehicle door by the outside activation lever 38 and thus by the outside door handle is possible.

Similar to the establishing of the above described functional states “unlocked” and “child-resistant unlocked”, all of the other above indicated functional states can also be implemented simply by a corresponding movement of the control shaft 2. The drive unit 3 is designed to move accordingly to all the functional states.

In regard to the movement of the positioning element 2, the drive unit 3 works like a direct drive unit, since there are no gear components of any kind between the positioning element 2 and the drive unit 3. Here, the drive unit 3 is not mechanically self-locking, which enables an easy manual establishing of functional states of the motor vehicle lock.

The design of the coil arrangement 6, especially the design and arrangement of the coils 12-15, holds in the present case very special importance. In the present case, the coil arrangement 6 has at least two, here precisely two coil pairs 12, 13; 14, 15, which are also actuated at least in pairs. Again, the first segment 6a of the coil arrangement 6 comprises at least one coil pair 12,13, here precisely one coil pair 12, 13, and the second segment 6b of the coil arrangement 6 comprises at least one coil pair 14, 15, here precisely one coil pair 14, 15, which are each actuated in pairs. Further, the two coils 12, 13; 14, 15 of a coil pair are electrically coupled, such as switched in series or in parallel.

It is especially of interest in the proposed drive unit 3 that at least two magnetically stable driving positions of the rotor 4, such as at least three magnetically stable driving positions of the rotor 4, such as more than three magnetically stable driving positions of the rotor 4 can be generated by different stationary current flow through the coil arrangement 6 and the concomitant magnetic interaction between rotor 4 and stator 5. Basically, even a total of eight mechanically stable driving positions of the positioning element 2 can be generated here.

In the sense of the above mentioned interpretation of the term “stationary current flow”, the current flow is only turned on, and not for example regulated in regard to a particular movement sequence or the like. It has also been explained already that the concept of “magnetically stable driving position” means in the present context that the rotor 4 during the current flow is constantly urged into the corresponding driving position by magnetic forces of attraction and repulsion, and this independently of the direction of a deflecting force acting from the outside. This means that a movement to the driving positions, corresponding to the respective control positions of the positioning element 2, can occur without the need for an end stop or the like. This reduces the noise and the wear and simplifies the mechanical design.

In some embodiments, at least two magnetically stable driving positions of the rotor 4, such as at least three magnetically stable driving positions of the rotor 4, such as more than three magnetically stable driving positions of the rotor 4 can be generated by current flow through the coils 12-15 of the coil arrangement 6 in a coil combination associated with the respective driving position in a direction of current flow associated with the respective driving position. The driving position reached depends solely on the energized coil combination as well as the direction of the current flow. This enables an especially simple design of a control unit associated with the coil arrangement 6.

In some embodiments, at least one magnetically stable driving position of an aforementioned control position of the positioning element 2 is used to establish a functional state of the lock mechanism 33 such as “locked”, “unlocked”, “theft-proof”, “child-resistant locked” and “child-resistant unlocked”. It is of special significance here that no further driving positions are provided between the driving positions which correspond each time to a control position of the positioning element 2. In this way, the respective driving positions can be reached directly, without several intermediate steps or intervening driving positions being needed.

According to a further teaching, regarding the drive unit 3 of the proposed motor vehicle lock, one should refer to all the remarks for the proposed motor vehicle lock.

According to a further teaching, regarding a method for actuating a proposed motor vehicle lock, what is important about this method is that the coil arrangement 6 experiences different stationary current flow for the occupying of at least two magnetically stable driving positions of the rotor 4, such as at least three magnetically stable driving positions of the rotor 4, and further more than three magnetically stable driving positions of the rotor 4. One should refer to all the remarks above regarding the actuation of the proposed motor vehicle lock.

It should be pointed out that the proposed drive unit 3 can be used inside the motor vehicle lock in quite different ways. Besides the establishing of functional states, the drive unit 3 can be used for example for a motorized lifting of the retaining pawl 40, since only small activation paths are needed for this.

Finally, it should further be pointed out for clarity that the components of the motor vehicle lock need not necessarily be accommodated in one and the same housing. In particular, it may be advantageous to provide the drive unit 3 in a housing designed otherwise separate from the motor vehicle lock, so that the motor vehicle lock can be arranged accordingly in a distributed fashion.

1. A motor vehicle lock having a positioning element and a drive unit for moving the positioning element, wherein the drive unit has a rotor and a stator, the stator having a coil arrangement and at least two magnetically conducting poles associated with the coil arrangement for conducting the magnetic field created by the coil arrangement,
wherein the poles each time form, with the rotor, an axial air gap relative to the geometrical rotor axis, and a first segment of the coil arrangement with at least one coil and a second segment of the coil arrangement with at least one coil are offset axially relative to each other in regard to the geometrical rotor axis and arranged along the geometrical rotor axis on opposite sides of the rotor.

2. The motor vehicle lock as claimed in claim 1, wherein at least one coil of the first segment of the coil arrangement is arranged with an angular offset in regard to the geometrical rotor axis with respect to the at least one coil of the second segment of the coil arrangement.

3. The motor vehicle lock as claimed in claim 1, wherein the magnetically conducting poles associated with the coil arrangement are arranged on opposite sides of the rotor along the geometrical rotor axis, and thus form with the rotor the axial air gaps in regard to the geometrical rotor axis on both sides of the rotor.

4. The motor vehicle lock as claimed in claim 1, wherein the rotor comprises a permanent magnet arrangement that is axially magnetized in relation to the geometrical rotor axis, and wherein the rotor is substantially disk-shaped and has at least two disk segments that are alternatingly magnetized opposite to each other.

5. The motor vehicle lock as claimed in claim 1, wherein at least a portion of the coils of the two segments of the coil arrangement overlap with each other when viewed in the direction of the geometrical rotor axis.

6. The motor vehicle lock as claimed in claim 1, wherein the first segment of the coil arrangement has at least two coils and the second segment of the coil arrangement has at least two coils.

7. The motor vehicle lock as claimed in claim 1, wherein at least one portion of the coils of the coil arrangement are oriented by their respective coil axes parallel to the geometrical rotor axis, and/or at least one of the two segments of the coil arrangement comprises at least one coil pair of two coils, whose coil axes lie on a connection line running through the geometrical rotor axis.

8. The motor vehicle lock as claimed in claim 6, wherein the coils of the first segment of the coil arrangement have the same angle position relative to each other with regard to the geometrical rotor axis as do the coils of the second segment of the coil arrangement.

9. The motor vehicle lock as claimed in claim 1, wherein the first segment of the coil arrangement is arranged with an angular offset in regard to the geometrical rotor axis from the second segment of the coil arrangement.

10. The motor vehicle lock as claimed in claim 1, wherein each pole is associated with at least one coil.

11. The motor vehicle lock as claimed in claim 1, wherein each pole is oriented to the coil axis of a coil associated with the respective pole.

12. The motor vehicle lock as claimed in claim 1, wherein each pole has a pole shoe, which faces toward the rotor in order to form the respective air gap.

13. The motor vehicle lock as claimed in claim 12, wherein at least a portion of the pole shoes associated with the two segments of the coil arrangement overlap each other when viewed in the direction of the geometrical rotor axis.

14. The motor vehicle lock as claimed in claim 13, wherein a pole shoe of a pole of a segment of the coil arrangement serves as a circuit closing element for two pole shoes of the respective other segment of the coil arrangement.

15. The motor vehicle lock as claimed in claim 1, wherein the poles are magnetically coupled in pairs via circuit closing plates.

16. The motor vehicle lock as claimed in claim 15, wherein the coils of the two segments of the coil arrangement are configured as identical parts and/or the poles of the two segments of the coil arrangement are configured as identical parts and/or the circuit closing plates of the two segments of the coil arrangement are configured as identical parts.

17. The motor vehicle lock as claimed in claim 1, wherein the coils and/or the poles have an elongated configuration, at least for a portion, in the cross section perpendicular to the geometrical rotor axis.

18. The motor vehicle lock as claimed in claim 1, wherein the motor vehicle lock comprises a lock mechanism which can be placed in different functional states.

19. The motor vehicle lock as claimed in claim 18, wherein the positioning element can be placed by the drive unit in at least two control positions, in order to establish the different functional states of the lock mechanism.

20. The motor vehicle lock as claimed in claim 18, wherein for the establishing of the different functional states at least one movable functional element is provided, the positioning element standing or being able to be brought into driving engagement with the functional element or being part of the functional element.

21. The motor vehicle lock as claimed in claim 20, wherein the functional element is designed as a wire or strip and it can be deflected into different functional positions.

22. The motor vehicle lock as claimed in claim 1, wherein the first segment of the coil arrangement comprises at least one coil pair, and the second segment of the coil arrangement comprises at least one coil pair, which are each actuated in pairs.

23. The motor vehicle lock as claimed in claim 1, wherein at least two magnetically stable driving positions of the rotor can be generated by different stationary current flow through the coil arrangement and the concomitant magnetic interaction between the rotor and the stator.

24. The motor vehicle lock as claimed in claim 1, wherein at least two magnetically stable driving positions of the rotor can be generated by current flow through the coils of the coil arrangement in a coil combination associated with the respective driving position in a direction of current flow associated with the respective driving position.

25. The motor vehicle lock as claimed in claim 19, wherein at least one magnetically stable driving position is a control position of the positioning element to establish a functional state of the lock mechanism.

26. A drive unit for moving a positioning element of a motor vehicle lock, wherein the drive unit has a rotor and a stator, the stator having a coil arrangement and at least two magnetically conducting poles associated with the coil arrangement for conducting the magnetic field created by the coil arrangement,
wherein the poles each time form, with the rotor, an axial air gap relative to the geometrical rotor axis, a first segment of the coil arrangement with at least one coil and a second segment of the coil arrangement with at least one coil are arranged on opposite sides of the rotor along the geometrical rotor axis.

27. A method for actuating a motor vehicle lock as claimed in claim 26, wherein the coil arrangement experiences different stationary current flow for the occupying of at least two magnetically stable driving positions of the rotor.

28. The method as claimed in claim 27, wherein, in order to occupy at least two magnetically stable driving positions, the coils of the coil arrangement experience a stationary current flow in a coil combination associated with the respective driving position in a flow direction associated with the respective driving position.
